(19) United States
(12) Patent Application Publication
(10) Pub. No.: US 2013/0284360 A1
(43) Pub. Date: Oct. 31, 2013

(54) ACTINICALLY CURABLE ADHESIVE COMPOSITION

(71) Applicants: ROBERT PAUL HELD, Newark, DE (US); Hassan Mohamed Farah, Diamond Bar, CA (US)

(72) Inventors: ROBERT PAUL HELD, Newark, DE (US); Hassan Mohamed Farah, Diamond Bar, CA (US)

(73) Assignee: E I DU PONT DE NEMOURS AND COMPANY, Wilmington, DE (US)

(21) Appl. No.: 13/587,270

(22) Filed: Aug. 16, 2012

Related U.S. Application Data
(63) Continuation-in-part of application No. 12/810,175, filed on Nov. 12, 2010.
(60) Provisional application No. 61/009,406, filed on Dec. 28, 2007.

(51) Int. Cl. C09J 133/14; C09J 5/00

(52) U.S. Cl. CPC C09J 133/14; C09J 5/00
USPC 156/275.7; 522/18; 522/33; 522/39; 522/64

(57) ABSTRACT

A photocurable adhesive composition is disclosed herein that has high adhesive strength and optical clarity and which in the cured state is reworkable and exhibits low propensities for exhibiting glow mark and pooling effects. The composition contains a chain transfer agent, an urethane (meth)acrylate having a plurality of ethylenically unsaturated groups, a (meth)acrylate monomer and a photoinitiator. The composition may optionally contain a light stabilizer.

### CROSS REFERENCE TO RELATED APPLICATIONS

This patent application is a continuation-in-part of U.S. patent application Ser. No. 12/810,175 filed on 28 Dec. 2008, which is currently pending and which claims benefit of priority under 35 U.S.C. §119(e) from U.S. Provisional Patent Application Ser. No. 61/009,406 filed on 28 Dec. 2007, both of which are incorporated by reference in their entirety.

### FIELD OF THE DISCLOSURE

The invention is directed to an actinically curable (photocurable) adhesive composition.

### BACKGROUND OF THE DISCLOSURE

In today's market, flat panel displays, such as liquid crystal displays (LCD), are often enhanced with specialized films. The films may be flexible or rigid. Such films are designed to optimize optical performance, e.g., viewing contrast, increasing brightness, removing glare, enhancing color and enhancing the clarity of the flat panel display or improve display functionality, such as bonding a touch panel to the front surface. The films are typically applied to the viewing side of the display. Application methods involve the use of an adhesive that is optically clear and pressure sensitive for easy bonding directly to the display.

Curable adhesives (e.g., heat or light cured) have been used in applications where substrates require substantial permanency and high strength adherence. Conventional adhesives (e.g., tape, silicone), however, are typically not easy to apply, or provide the benefits of curable adhesives. An adhesive material for application of a film to a base material is described in U.S. Pat. No. 6,139,953. For optical product applications, curable adhesives have been desirable, as they can provide optically clear, strongly adhered laminates (e.g., layered substrates).

To achieve both strength and ease of application, hybrid compositions have been developed that can be used in optical applications. For example, a light curable, polyester based adhesive has been used for plastic glazing applications. In digital video disc (DVD or optical discs) bonding and cathode ray tube (CRT) applications, a liquid adhesive formulation has been used. For bead bonding in making retroreflective articles, a curable polymeric network has been suggested.

Strength and application, however, are not the only criteria that many optical substrates/laminates require. Certain optical products are exposed to harsh environmental conditions, such as heat, UV (solar) light, water, etc. For example, vehicle windshields generally exist in outdoor conditions that submit them to all types of weather. These windshields typically include substrates such as acrylic or polycarbonate, adhered to a solar or infra-red (IR) reflecting film made from a multi-layer optical film (MLOF) (3M Co., St. Paul, Minn.). The materials may become optically obstructed if the adhesion between the layers is damaged or compromised.

Light curable liquid acrylic ester adhesives for glass bonding using low intensity ultraviolet (“UV”) light are known. Such adhesives are useful for glass assembly and repair applications in which high intensity UV light is unavailable or impractical.

A number of fast curing low-yellowing acrylate functional oligomer products are known for use in UV/electron beam (“EB”) curable printing inks and the like. However, such products typically have poor adhesive strength to glass.

It is desirable and often necessary for a viable commercial UV/visible curable adhesive suitable for glass bonding to possess several key properties—e.g., having good adhesive strength, fast tact time, optical clarity and reduced yellowing. An additional key property that is highly desirable in an optical adhesive (in the cured state) targeted for use in display applications is reworkability. With regard to reworkability, one or more events can occur during manufacture, shipping, and/or in use that requires the film and adhesive to be removed easily and cleanly from the display and replaced. Some examples of such events are 1) defects in bonding during application of the specialized film to the display may necessitate on-site repair, 2) damage to a LCD occurring during its use, and 3) a component (e.g., LCD, glass, touch panel) of a device becoming defective after placement in the device. Present commercially-available adhesives and associated methods fall short with regard to reworkability and with regard to one or more of the above-mentioned other key properties. The present invention offers a solution towards reworkability in providing an effective composition and associated method that are compatible with rework processing such as that disclosed in copending U.S. patent application 13/120,458.

### SUMMARY OF THE DISCLOSURE

In an embodiment, the invention is an actinically curable adhesive composition comprising:
a) an aliphatic urethane acrylate having a plurality of ethylenically unsaturated groups;
b) a meth(acrylate) monomer;
c) a photoinitiator;
d) a plasticizer; and
e) pentaerythritol tetrakis(3-mercaptopropionate);
   wherein the level of (meth)acrylate monomer plus the level of plasticizer together range from 30 weight percent to 50 weight percent of the total weight of the composition.

In another embodiment, the invention is a method of bonding a substrate to a liquid crystal display, said method comprising the steps of:

1) applying an actinically curable adhesive composition comprising:
a) an aliphatic urethane acrylate having a plurality of ethylenically unsaturated groups;
b) a meth(acrylate) monomer;
c) a photoinitiator;
d) a plasticizer; and
e) pentaerythritol tetrakis(3-mercaptopropionate);
   to a surface selected from the group consisting of a surface of the liquid crystal display, a surface of the substrate, and both a surface of the liquid crystal display and a surface of the substrate; wherein the level of (meth)acrylate monomer plus the level of plasticizer together range from 30 weight percent to 50 weight percent of the total weight of the composition;
   2) contacting the surface of the substrate with the actinically curable adhesive composition and the liquid crystal display such that the adhesive is sandwiched between the surface of the substrate and the surface of the liquid crystal display; and
   3) exposing the actinically curable adhesive composition to actinic radiation at a sufficient level to at least partially cure the actinically curable adhesive composition and thereby afford a bonded liquid crystal display/substrate element.

### GLOSSARY OF TERMS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. The materials, methods, and examples described herein are illustrative only and not intended to be limiting.

### BRIEF DESCRIPTION OF THE DRAWINGS

FIG. 1 illustrates a shaded cure test structure and an associated test method as discussed herein (in Examples 16-19).

### DETAILED DESCRIPTION

In various embodiments, the invention is an actinically curable adhesive composition comprising:

a) an aliphatic urethane acrylate having a plurality of ethylenically unsaturated groups;
b) a meth(acrylate) monomer;
c) a photoinitiator;
d) a plasticizer; and
e) pentaerythritol tetrakis(3-mercaptopropionate);
wherein the level of (meth)acrylate monomer plus the level of plasticizer together range from 30 weight percent to 50 weight percent of the total weight of the composition.

All weight percentages found herein are based on total composition, and all ranges include any range or value contained therein.

In this invention, pentaerythritol tetrakis(3-mercaptopropionate). is present as a chain transfer agent to control molecular weight of the photopolymer produced upon photopolymerization of the actinically curable adhesive composition. The chain transfer agent may be present in the adhesive compositions in an amount ranging from about 3-10 weight % and preferably from about 4-7 weight If the level of chain transfer agent is less than approximately 3 weight %, the adhesive upon curing will be too stiff, and it will have too high a modulus, such that undesirable pooling and “halo” effects (e.g., glow marks) in LCD displays will likely result when the adhesive of this composition is utilized in LCD displays. If the level of the chain transfer agent is greater than approximately 10 weight %, the adhesive upon curing will lack sufficient strength to be suitable in display applications.

The composition of this invention includes a photopolymerizable urethane (meth)acrylate having a plurality of ethylenically unsaturated groups. The urethane (meth)acrylate can either be a urethane acrylate or a urethane methacrylate and is preferably a urethane acrylate. In an embodiment, the urethane (meth)acrylate is an aliphatic urethane diacrylate. The urethane (meth)acrylate is present in the composition in the range of about 30-60 weight % based on total composition. If the level of urethane (meth)acrylate is greater than approximately 60 weight %, the solution viscosity of the composition is too high and, consequently, the composition is not amenable to necessary degassing prior to photocuring. If the level of urethane (meth)acrylate is less than about 30 weight %, the solution viscosity is too low and, consequently, the cured adhesive is dry/hard and is not sticky or flexible and the flow of adhesive during application is too slow to effectively fill the area. These properties in the cured adhesive are undesirable in that they correspond to the cured adhesive having high propensities for displays bonded using these adhesives to exhibit undesirable pooling and glow mark effects as well as for displays bonded with these adhesives to not be reworkable. Furthermore, such undesirable properties may lead to delamination of displays.

In some embodiments, the urethane (meth)acrylate may be selected from CN9023, CN-9002 (Sartomer Company, Exton, Pa.), Ebecryl® 230 (aliphatic urethane diacrylate), Ebecryl® 244 (aliphatic urethane diacrylate diluted 10% with 1,6-hexanediol diacrylate), Ebecryl® 264 (aliphatic urethane triacrylate diluted 15% with 1,6-hexanediol diacrylate), Ebecryl® 284 (aliphatic urethane diacrylate diluted 10% with 1,6-hexanediol diacrylate), CN-961 E75 (aliphatic urethane diacrylate blended with 25% ethoxylated trimethylol propane triacrylate), CN-961 H81 (aliphatic urethane diacrylate blended with 19% 2(2-ethoxyethoxy)ethyl acrylate), CN-963A80 (aliphatic urethane diacrylate blended with 20% tripropylene glycol diacrylate), CN-964 (aliphatic urethane diacryate), CN-966A80 (aliphatic urethane diacrylate blended with 20% tripropylene glycol diacrylate), CN-982A75 (aliphatic urethane diacrylate blended with 25% tripropylene glycol diacrylate) and CN-983 (aliphatic urethane diacrylate), FAIRAD 8010, FAIRAD 8179, FAIRAD 8205, FAIRAD 8210, FAIRAD 8216, FAIRAD 8264, M-E-15, UVU-316, ALU-303, and Genomer 4652. In one embodiment, the urethane (meth)acrylate is Sartomer CN-9023 (aliphatic urethane diacrylate). Additional examples of suitable commercially-available urethane (meth)acrylates include CN9002, CN963, CN964, CN965, CN966, CN970, CN973, and CN990, all of which are available from Sartomer (Exton, Pa.). Ebecryl® urethane (meth)acrylates are available from Cytec Surface Specialties, Brussels, Belgium. Urethane (meth)acrylates listed above with a CN-xxx designation are available from Sartomer (Exton, Pa.). FAIRAD urethane (meth)acrylates are available from Fairad Technology Inc., Morrisville, Pa. M-E-15, UVU-316, ALU-303, and Genomer 4652 urethane (meth)acrylates are, respectively, available from Rahn AG (1005 N′ Commons Drive, Aurora, Ill.).

In various embodiments, the urethane (meth)acrylate can have a formula (I):

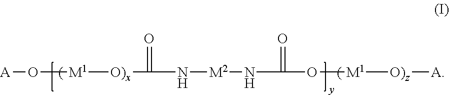

Each M¹ is, independently, an alkylene, an acylalkylene, an oxyalkylene, an arylene, an acylarylene, or an oxyarylene. Each M² is, independently, an alkylene or an arylene. Each M¹ and each M² are optionally substituted with alkyl, cycloalkyl, alkenyl, cycloalkenyl, alkynyl, acyl, alkoxy, hydroxyl, hydroxyalkyl, halo, haloalkyl, amino, silicone, aryl, or aralkyl. In formula (I), x is a positive integer less than 40, y is a positive integer less than 100, and z is a positive integer less than 40. Each A, independently, has the formula:

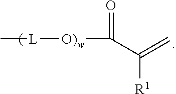

R¹ is hydrogen or lower alkyl, each L is, independently, C₁-C₄ alkyl, and w is an integer ranging from 0 to 20. In formula (I), w, x, y, and z together are selected such that the molecular weight of the urethane (meth)acrylate is less than 20,000. More particularly, M¹ can be acylalkylene and M² can be alkylene or arylene.

A (meth)acrylate monomer is another component of the compositions of this invention. The (meth)acrylate monomer may contain 7-18 carbon atoms, preferably 9-15 carbon atoms, and more preferably 9-12 carbon atoms in addition to oxygen and hydrogen atoms and optionally other atoms (e.g., sulfur, nitrogen). The carbon atoms can be present as either aromatic or aliphatic groups. Non-limiting examples of methacrylate monomers include cyclic trimethylolpropane formal acrylate (SR-531 from Sartomer Co., Exton, Pa.) and 2-phenoxyethyl acrylate (SR-339 from Sartomer Co., Exton, Pa.) In one more preferred embodiment, an alkyl group (e.g., octyl and decyl) is present in the monomer. In another preferred embodiment isobornyl acrylate is the monomer. Also a mixture of (meth)acrylate monomers can be used. The (meth)acrylate monomer is mono-functional. The (meth)acrylate monomer(s) is present in a range of about 10 weight percent to about 50 weight percent and preferably from about 15 weight percent to about 40 weight percent. In some embodiments, the (meth)acrylate(s) monomer is present in a range of about 19 weight percent to about 36 weight percent.

A plasticizer is another component of the compositions of this invention. In an embodiment, the plasticizer can be any compound or class of compounds known to exhibit plasticizer properties. In another embodiment, the plasticizer can be any plasticizer or class of plasticizers that are disclosed in “The Technology of Solvents and Plasticizers”, by Arthur K. Doolittle, John Wiley & Sons, Inc., New York, 1954; see Chapters 15 and 16 in particular. In another embodiment, non-limiting examples of suitable plasticizers include, but are not limited to, dibutoxyethoxyethyl formal (Cyroflex SR660) or dibutoxyethoxyethyl adipate (Wareflex SR650), both of which are available from Sartomer Company (Exton, Pa.). In another embodiment, the plasticizer is dibutoxyethoxyethyl formal (Cyroflex SR660) or dibutoxyethoxyethyl adipate (Wareflex SR650), both of which are available from Sartomer Company (Exton, Pa.). In another embodiment the plasticizer is TegMer® 804S (tetraethylene glycol di-2-ethylhexoate) or TegMer® 809 (PEG 400 Di-2-ethylhexoate, which is polyethylene glycol di-2-ethylhexoate, where the polyethylene glycol (PEG) portion of this compound has a number average molecular weight of 400) manufactured by the Hallstar Company, Chicago, Ill. The plasticizer is present in a range of about 3 weight percent to about 40 weight percent, preferably from about 5 weight percent to about 15 weight percent, and more preferably from about 6 weight percent to about 13 weight percent. In some embodiments, the plasticizer is present in a range of about 5 weight percent to about 10 weight percent.

In this invention, there are ranges for the levels added together (meth)acrylate monomer and plasticizer that are suitable. Broadly, the level of (meth)acrylate monomer plus the level of plasticizer (added together) can range from about 30 weight percent to about 50 weight percent, preferably can range from about 35 weight percent to about 50 weight percent, and more preferably can range from about 40 weight percent to about 48 weight percent. If the level of the (meth)acrylate monomer plus the level of the plasticizer is greater than about 50 weight %, the solution viscosity is low and consequently, the cured adhesive is dry/hard and is not sticky (desirable) or flexible; these properties in the cured adhesive are not amenable to reworkability of the cured adhesive when necessary and may lead to delamination of displays manufactured using adhesives with such properties. If the level of the (meth)acrylate monomer plus the level of the plasticizer is less than about 30 weight %, the solution viscosity of the composition is high and, consequently, the composition is not amenable to necessary degassing prior to photocuring.

To initiate polymerization of the monomers upon exposure to actinic radiation, the composition of this invention includes a photoinitiator or photoinitiator system. Suitable photoinitiators include, but are not limited to, difunctional alpha-hydroxy ketone (Esacure® ONE from Lamberti USA, Inc. Conshohocken, Pa.), 2,4,6-trimethylbenzoyldiphenylphosphine oxide (Esacure® TPO from Lamberti USA, Inc., Conshohocken, Pa.), Irgacure® 184 (1-hydroxycyclohexyl phenyl ketone), Irgacure® 907 (2-methyl-1-[4-(methylthio)phenyl]-2-morpholino propan-1-one), Irgacure® 392 (2-benzyl-2-N,N-dimethylamino-1-(4-morpholinophenyl)-1-butanone), Irgacure® 500 (the combination of 50% 1-hydroxy cyclohexyl phenyl ketone and 50% benzophenone), Irgacure® 651 (2,2-dimethoxy-1,2-diphenylethan-1-one), Irgacure®1700 (the combination of 25% bis(2,6-dimethoxybenzoyl-2,4-,4-trimethyl pentyl) phosphine oxide,

and 75% 2-hydroxy-2-methyl-1-phenyl-propan-1-one), DAROCUR® 1173 (2-hydroxy-2-methyl-1-phenyl-1-propane), and DAROCUR® 4265 (the combination of 50% 2,4,6-trimethylbenzoyldiphenyl-phosphine oxide and 50% 2-hydroxy 2-methyl-1-phenyl-propan-1-one); these photoinitiators are available commercially from Ciba-Geigy Corp., Tarrytown, N.Y. Some additional suitable photoinitiators are CYRACURE® UVI-6974 (mixed triaryl sulfonium hexafluoroantimonate salts) and CYRACURE® UVI-6990 (mixed triaryl sulfonium hexafluorophosphate salts) available commercially from Union Carbide Chemicals and Plastics Co., Inc., Danbury, Conn.; and Genocure® CQ, Genocure® BOK, and Genocure® M.F., commercially available from Rahn Radiation Curing; and others include benzophenone, 2-hydroxy-2-phenyl acetophenone, benzoin isopropyl ether, 2,4,6-trimethyl benzoyl diphenylphosphine oxide, methylphenyl glyoxylate, 1-phenyl-1,2-propane dion-2-o-ethoxycarbonyl oxime, and substituted and unsubstituted hexaphenyl biimidazole dimmers. Preferred photoinitiators include Esacure® ONE and Esacure® TPO, both from Lamberti USA, Inc., Conshohocken, Pa. Combinations of these materials may also be employed herein.

Phosphine oxide type photoinitiators are preferred for shaded cure applications. Examples of suitable phosphine oxide photoinitiators include, but are not limited to, phenyl bis(2,4,6-trimethyl benzoyl)phosphine oxide (Irgacure 819) and 2,4,6-trimethylbenzoyldiphenylphosphine oxide (Esacure® TPO).

The photoinitiator may be present in the adhesive compositions in an amount ranging from about 0.1-2 weight % of the total composition and preferably is present in an amount ranging from about 0.2-1.2 weight % of the total composition. If the photoinitiator is present at a level that is less than about 0.1 weight %, the cure rate is too low to be acceptable and/or is near zero. If the photoinitiator is present at a level that is greater than about 2 weight %, there is no advantage in having a higher level and/or the propensity of the composition to yellow may be increased.

The photocurable adhesive composition as described above may optionally include a light stabilizer. Some non-limiting examples of suitable light stabilizers are Tinuvin® 292 (bis(1,2,2,6,6-pentamethyl-4-piperidyl)sebacate and 1-methyl-10-(1,2,2,6,6-pentamethyl-4-piperidyl)sebacate), and Tinuvin® 765 (bis(1,2,2,6,6,-pentamethyl-4-piperidyl)sebacate) both available from Ciba Specialty Chemicals; BLS 292 (bis(1,2,2,6,6-pentamethyl-4-piperidyl)sebacate and 1-(methyl)-10-(1,2,2,6,6-pentamethyl-4-piperidyl)sebacate) available from Mayzo Inc.; MEHQ (4-methoxyphenol) available from Aldrich Chemical Company; and, LA-32 and LA-82 available from ADK Stab; and Chimassorb® 81 available from Ciba Specialty Chemicals. A stabilizer that is a hindered amine light stabilizer (HALS) is preferred. In one embodiment, a HALS stabilizer is selected from the group consisting of Tinuvin® 123 (decanedioic acid, bis(2,2,6,6-tetramethyl-4-piperidinyl)ester, reaction products with tert-Bu hydroperoxide and octane), Tinuvin® 765 (bis(1,2,2,6,6-pentamethyl-4-piperidyl)sebacate) and Tinuvin® 292 (bis(1,2,2,6,6-pentamethyl-4-piperidyl)sebacate and 1-(methyl)-10-(1,2,2,6,6-pentamethyl-4-piperidyl)sebacate). Tinuvin® 123, Tinuvin® 765 and Tinuvin® 292 are available from Ciba Specialty Chemicals. In another embodiment. Tinuvin® 765 (bis(1,2,2,6,6-pentamethyl-4-piperidyl)sebacate) is the light stabilizer. In another embodiment, Tinuvin® 123 is the light stabilizer.

When present in the composition, the light stabilizer can be present in an amount ranging from about 0.01-0.7 weight %, preferably about 0.01-0.5 weight %, more preferably about 0.025-0.15 weight %, and still more preferably about 0.025-0.12 weight %, based on the total composition. When the level of stabilizer is above about 0.7 weight % in a composition, the viscosity of the uncured composition may increase with time (over less than or equal to 3 months) to an unacceptable level for there to be adequate product shelf life. When the level of stabilizer is below about 0.010 weight %, its effectiveness as a light stabilizer is poor.

While not being bound by any theory, the inventors believe that the levels of plasticizer and chain transfer agent are particularly important for the compositions of their invention such that the cured compositions will have suitable balance of stiffness and softness to afford good adhesion, impart reworkability in devices using the adhesive, and reduce or eliminate the undesirable effects of glow marks and pooling. Increasing the level of either chain transfer agent or plasticizer in the inventive compositions affords a softer polymer in the cured state having lower modulus.

The compositions of this invention upon curing exhibit a modulus of less than or equal to 0.27 megapascals. In an embodiment, the modulus ranges from about 0.01 megapascals to about 0.1 megapascals. In another embodiment, the modulus ranges from about 0.016 megapascals to about 0.05 megapascals. In one embodiment, the modulus ranges from 0.016 megapascals to 0.05 megapascals.

As was indicated above in an embodiment, the invention is a method of bonding a substrate to a liquid crystal display, said method comprising the steps of:

1) applying an actinically curable adhesive composition comprising:
a) an aliphatic urethane acrylate having a plurality of ethylenically unsaturated groups;
b) a (meth)acrylate monomer;
c) a photoinitiator;
d) a plasticizer; and
e) pentaerythritol tetrakis(3-mercaptopropionate);
   to a surface selected from the group consisting of a surface of the liquid crystal display, a surface of the substrate, and both a surface of the liquid crystal display and a surface of the substrate; wherein the level of (meth)acrylate monomer plus the level of plasticizer together range from 30 weight percent to 50 weight percent;
   2) contacting the surface of the substrate with the actinically curable adhesive composition and the liquid crystal display such that the adhesive is sandwiched between the surface of the substrate and the surface of the liquid crystal display; and
   3) exposing the actinically curable adhesive composition to actinic radiation at a sufficient level to at least partially cure the actinically curable adhesive composition and thereby afford a bonded liquid crystal display/substrate element.

The applying step can include applying any of the actinically curable adhesive compositions described herein. The method of applying the adhesive includes, but is not limited to, pouring the adhesive on a surface or surfaces of the LCD and/or substrate, applying robotically a measured amount of adhesive to one or both of these surfaces and brushing/painting the adhesive onto one or both of these surfaces.

The method can be used to bond together any type of liquid crystal display to virtually any substrate. Suitable substrates include, but are not limited, to glass plates (e.g., antireflective plates), polymeric films, and touch panels.

The contacting step 2) of the method can include any method or means of bringing the uncured adhesive simultaneously in contact with a surface of the LCD that is to be bonded with the adhesive and a surface of the substrate that is to be bonded with the adhesive such that the adhesive (still uncured) is sandwiched between these two surfaces (one of the LCD and one of the substrate).

The exposing step 3) can be made with any type of actinic radiation that is effective in curing the particular adhesive composition being utilized for bonding. Exposing with actinic radiation that is predominantly in the ultraviolet region (approximately 180 nm-350 nm) of the electromagnetic spectrum at a level that is sufficient to at least partially cure the actinically curable adhesive composition is preferred.

Execution of the method of the invention results in a substrate being adhesively bonded to a LCD by means of the cured adhesive to afford a LCD/substrate element. An example of such an element is a antireflective glass plate being bonded to a LCD to produce an enhanced LCD having improved antireflective properties.

### DEFINITIONS

Glow mark—A glow mark is a visual aberration/deformity in the appearance of an LCD when a portion of the LCD is under more stress than other portions of it. An LCD having a glass plate, for example, bonded to it with an adhesive, can have portions (particularly near the edges) that are under higher stress if the modulus of the cured adhesive is too high. In this case, this bonded LCD may exhibit glow marks which are undesirable. In this invention, glow marks are rated for their severity using the following 0-5 scale:

0=No glow mark observed
1=Glow mark(s) just visible off-axis or on-axis, light yellow
2=Glow mark(s) obvious on-axis, medium yellow
3=See objectionable discoloration, heavy yellow
4=See severe discoloration, golden yellow-light brown
5=See dark yellow-brown

Pooling—Pooling is an undesirable pressure-induced distortion of an LCD panel such that the LCD display being subjected to pressure is susceptible to exhibiting a wave motion of liquid crystal material that is undesirable in comparison to a uniform display under pressure that exhibits no such observable pressure-induced defects. Pooling is particularly undesirable in notebook tablet displays where a stylus is used to write information to the display since irrelevant information is observable on the display that is distracting and precludes having a desirable uniform display background. In this invention, pooling effects in adhesively bonded displays are rated for their severity using the following 0-5 scale:

0=No pooling observed
1=Slight pooling near edge(s)
2=Medium low level of pooling
3=Medium level of pooling
4=Medium high level of pooling
5=High level of pooling

Reworkability—Reworkability of an adhesively-bonded display (e.g., LCD) in this invention is defined to mean that the cured bonded adhesive when desired or necessary can, without undue difficulty or long time requirement(s), be cleanly and effectively removed during disassembly of the display to remove a substrate (e.g., film or glass plate or touch panel) from being bonded to the display by the cured adhesive layer. An example where reworkability is desired and needed is when an air bubble or other defect is found in a bonded display. Other examples where reworkability is desired include cases where a component in a display becomes defective or there is damage to part of a display in use. In one or more of these events, it is highly desirable that the substrate and adhesive be removed from the display such that the bonding process can afterwards be repeated hopefully to afford a bonded display without the flaw, damage, or defect being present subsequent to reworking. If reworking is not feasible, then the defective bonded display cannot typically be corrected and is usually then discarded, which corresponds to a relatively high value loss of the display as well as the film or plate.

More specifically, a cured adhesive (bonding a substrate to an LCD) that is reworkable is one that is compatible with a thread, a wire or other rework tool to be drawn/sliced/cut through it and thereby afford a basically clean separation of the substrate from the LCD. Typically after this drawing/slicing/cutting step, both the adhesive side of the LCD and the adhesive side of the substrate will have some residual adhesive on these two sides. Furthermore, subsequent to this step, a good adhesive that is reworkable is one that provides a clean separation of adhesive from the substrate, the LCD, and/or other parts being bonded with the adhesive.

The term “module” as used herein is intended to cover display component assemblies and subassemblies.

### EXAMPLES

### Test Methods

Test methods and parameters as well as key information defining each test type are given below.

### Tensile Measurements

Tensile measurements of elastic modulus and the engineering stress at 33% strain were made using straight sided strips (nominally 127 mm×30 mm×1.5 mm) of cured resin on a universal materials tester manufactured by Instron (Canton, Mass.). The tensile tests were conducted at 24° C. at a test rate of 279 mm/min with an initial grip separation of 76 mm. The strain was calculated using the initial grip separation. The stress was calculated using the initial dimensions. The resulting stress-strain plots afforded elastic modulus values reported in MPA (mega pascals).

### Bonding Preparation Using LCD Fixture

An LCD fixture was prepared for bonding an LCD to a glass plate using a given photocurable adhesive sample and also using a dam technique in a laboratory method which confines uncured liquid adhesive only in areas where bonding is desired. The dam used was a raised tape edging together with shims to define the thickness level of cured adhesive. The adhesive was poured into the “dammed” area of the fixture. The glass was then placed onto the adhesive with the adhesive spread out so there were no visible air bubbles. This fixture was then UV light cured to yield a photocured adhesive layer between the glass and the LCD fixture (polarizer surface) using UV light equipment discussed below.

### Curing and Testing of Adhesive Cured Samples

The UV light was a Fusion UV conveyor belt transport, manufactured by Fusion UV Systems, Inc., Gaithersburg, Md., using a Fusion UV “D” bulb. The intensity was set at 2.813 W/cm2 with the exposure being about 6.77 J/cm2. The fixture was transported through the exposure unit at about 3 ft./min. The samples used to measure the modulus and mean stress versus strain curves were made in a Teflon® coated steel fixture with a well about 2 inches by 6 inches with a depth of about 2 mm. The liquid adhesive is placed in this fixture well and sent through the UV curing Fusion light source to provide a cured “strip” of adhesive which is placed in an Instron unit to measure the pull forces which yields a stress versus strain curve of the cured adhesive layer from which we get the modulus and the stress at a given % strain (e.g., 33% strain which is approximately a 1 inch stretching).

### Examples 1-15

### Adhesive Samples

Samples of the different adhesive compositions shown in Table 1 were made up with the component levels as shown in Table 1 (in weight percent units). Adhesive batch sizes for these compositions were in range of 500-2500 grams.

### Glow Mark Testing

The glow mark tests reported in Table 1 were done at 50° C.

### Reworkability Testing

In the reworkability experiments reported in Table 1 for various adhesive compositions, a given adhesive was used to bond a glass plate to either a NEC or Toshiba LCD panel. To test reworkability, a given bonded LCD panel was heated and then a wire was used to “slice through” the adhesive layer and to thereby initiate separation of the glass plate from the LCD at the adhesive interface. The wire was held at both ends by a technician such that it had a U-shape as it was drawn through the cured adhesive layer in a “saw-like” movement to effect de-bonding. What is meant by “saw-like” movement is that the technician first incrementally advanced the wire further through either the left or right side of the LCD and then switched to incrementally advancing the wire further on the other side (right or left). This pattern was repeated as many times as was necessary to debond the LCD.

Two levels of reworkability are reported in Table 1. In “Pass-level 1”, an operator can using a wire tool slice through and remove the adhesive from the LCD and glass within a short period of less than or equal to 2 minutes without damaging the LCD and cover plate surfaces and. In “Pass-level 2”, an operator can remove the adhesive but its removal is not as clean and requires a longer time than two minutes.

NEC NL10276BC24-13 LCD panels were purchased from NEC Electronics America, Inc., P.O. Box 951154, Dallas, Tex. 75395-1154.

Toshiba LTD121KM2M LCD panels were purchased from Toshiba America Electronic Components, P.O. Box 99421, Los Angeles, Calif. 90074.

TABLE 1
Adhesive Formulations and Test Data
Examples 1-4

| | | Example 2 | | |
|---|---|---|---|---|
| | Example 1 | (Comparative) | Example 3 | Example 4 |
| Ingredient | | | | |
| Oligomer - aliphatic urethane | 55 | 55 | 55 | 47.5 |
| acrylate (Sartomer CN9002) | | | | |
| Oligomer aliphatic urethane | | | | |
| acrylate (Cytec Ebecryl 230) | | | | |
| Monofunctional Monomer - cyclic | 17 | 24 | 7 | 14.5 |
| trimethylolpropane formal acrylate | | | | |
| (Sartomer SR531) | | | | |
| Monofunctional Monomer - | | | | |
| phenoxyethyl acrylate (Sartomer | | | | |
| SR339) | | | | |
| Monofunctional Monomer - | | | | |
| isobornyl- acrylate (Sartomer | | | | |
| SR506A) | | | | |
| Plasticizer - dibutoxy- ethoxyformal | 20 | 20 | 30 | |
| (Sartomer Cryoflex SR660) | | | | |
| Plasticizer - dibutoxyethoxy- ethyl | | | | 30 |
| adipate (Sartomer Wareflex SR650) | | | | |
| Chain Transfer Agent - penta- | 7 | 0 | 7 | 7 |
| erythritol tetrakis(3-mercapto- | | | | |
| proprionate) [PET AMAP] | | | | |
| Chain Transfer Agent - 2-mer- | | | | |
| captobenzothiazole | | | | |
| Photoinitiator - 2,4,6-trimethyl- | 0.5 | 0.5 | 0.5 | 0.5 |
| benzoylphenylphosphine oxide | | | | |
| (Esacure TPO) | | | | |
| Photoiniator difunctional α-hydroxy | 0.5 | 0.5 | 0.5 | 0.5 |
| ketone (Esacure ONE) | | | | |
| Photoiniator - 1-hydroxy-cyclohexyl- | | | | |
| phenyl-ketone (Ciba Irgacure 184) | | | | |
| Surfactant - Zonyl FSO-100 | | | | |
| Test Data | | | | |
| Modulus (from Instron testing) [Mpa] | 0.258 | 1.047 | 0.161 | 0.128 |
| Mean stress [Mpa] at 33% strain | 0.066 | 0.267 | 0.044 | 0.033 |
| Reworkability on Toshiba | | | | |
| LTD121KM2M | | | | |
| Reworkability on NEC NL | | | | Yes <20 |
| 10276BC24-13 | | | | seconds |
| Glow marks on Toshiba | 4 | Should give | Should give | 1 |
| LTD121KM2M | | rating of 5 | rating of 3 | |
| Glow marks on NEC NL | 2 | 5 | 3 | 3 |
| 10276BC24-13 | | | | |
| Pooling on LTD 121KM2M | Should give | Should give | Should give | 0 |
| | rating of | poor rating of | rating of | |
| | about 0-2 | about 3-4 | about 0-2 | |

Examples 5-8

| | Example 5 | Example 6 | Example 7 | Example 8 |
|---|---|---|---|---|
| Ingredient | | | | |
| Oligomer - aliphatic urethane | 47 | 47 | 47 | 47 |
| acrylate (Sartomer CN9002) | | | | |
| Oligomer - aliphatic urethane | | | | |
| acrylate (Cytec Ebecryl 230) | | | | |
| Monofunctional Monomer - cyclic | | | | |
| trimethylolpropane formal acrylate | | | | |
| (Sartomer SR531) | | | | |
| Monofunctional Monomer - | 27 | 21 | 23 | 31 |
| phenoxyethyl acrylate (Sartomer | | | | |
| SR339) | | | | |
| Monofunctional Monomer - | | | | |
| isobornyl- acrylate (Sartomer | | | | |
| SR506A) | | | | |
| Plasticizer - dibutoxy- ethoxyformal | | | | |
| (Sartomer Cryoflex SR660) | | | | |
| Plasticizer - dibutoxyethoxy- ethyl | 20 | 25 | 25 | 15 |
| adipate (Sartomer Wareflex SR650) | | | | |
| Chain Transfer Agent - penta- | 5 | 6 | 4 | 6 |
| erythritol tetrakis(3-mercapto- | | | | |
| proprionate) [PET AMAP] | | | | |
| Chain Transfer Agent - 2-mer- | | | | |
| captobenzothiazole | | | | |
| Photoinitiator - 2,4,6-trimethyl- | | | | |
| benzoylphenylphosphine oxide | | | | |
| (Esacure TPO) | | | | |
| Photoiniator - difunctional α-hydroxy | 1 | 1 | 1 | 1 |
| ketone (Esacure ONE) | | | | |
| Photoiniator - 1-hydroxy-cyclohexyl- | | | | |
| phenyl-ketone (Ciba Irgacure 184) | | | | |
| Surfactant - Zonyl FSO-100 | | | | |
| Test Data | | | | |
| Modulus (from Instron testing) [Mpa] | 0.178 | 0.083 | 0.234 | 0.12 |
| Mean stress [Mpa] at 33% strain | 0.047 | 0.023 | 0.064 | 0.031 |
| Reworkability on Toshiba | Fail | Fail | Pass | Fail |
| LTD121KM2M | | | | |
| Reworkability on NEC NL | Pass - | Pass - | Pass - | Pass - |
| 10276BC24-13 | level 2 | level 1 | level 1 | level 2 |
| Glow marks on Toshiba | 0 | 1 | 0 | 0 |
| LTD121KM2M | | | | |
| Glow marks on NEC NL | 0.5 | 0 | 2 | 0 |
| 10276BC24-13 | | | | |
| Pooling on LTD 121KM2M | 2 | 3 | 3 | 3 |

Examples 9-12

| | | | Example 11 | |
|---|---|---|---|---|
| | Example 9 | Example 10 | [Comparative] | Example 12 |
| Ingredient | | | | |
| Oligomer aliphatic urethane | 47 | 47 | | 47.5 |
| acrylate (Sartomer CN9002) | | | | |
| Oligomer - aliphatic urethane | | | 46.4 | |
| acrylate (Cytec Ebecryl 230) | | | | |
| Monofunctional Monomer - cyclic | | | | |
| trimethylolpropane formal acrylate | | | | |
| (Sartomer SR531) | | | | |
| Monofunctional Monomer - | 33 | 27 | | 24.3 |
| phenoxyethyl acrylate (Sartomer | | | | |
| SR339) | | | | |
| Monofunctional Monomer | | | 44.5 | |
| isobornyl- acrylate (Sartomer | | | | |
| SR506A) | | | | |
| Plasticizer - dibutoxy- ethoxyformal | | | | |
| (Sartomer Cryoflex SR660) | | | | |
| Plasticizer - dibutoxyethoxy- ethyl | 15 | 20 | | 20 |
| adipate (Sartomer Wareflex SR650) | | | | |
| Chain Transfer Agent - penta- | 4 | 5 | 5.8 | 7 |
| erythritol tetrakis(3-mercapto- | | | | |
| proprionate) [PET AMAP] | | | | |
| Chain Transfer Agent - 2-mer- | | | | |
| captobenzothiazole | | | | |
| Photoinitiator - 2,4,6-trimethyl- | | | | |
| benzoylphenylphosphine oxide | | | | |
| (Esacure TPO) | | | | |
| Photoiniator - difunctional α-hydroxy | 1 | 1 | | 1 |
| ketone (Esacure ONE) | | | | |
| Photoiniator - 1-hydroxy-cyclohexyl- | | | 1.6 | |
| phenyl-ketone (Ciba Irgacure 184) | | | | |
| Surfactant - Zonyl FSO-100 | | 0.2 | | 0.2 |
| Test Data | | | | |
| Modulus (from Instron testing) [Mpa] | 0.274 | 0.208 | 0.38 | |
| Mean stress [Mpa] at 33% strain | 0.073 | 0.055 | 0.03 | |
| Reworkability on Toshiba | Pass | Fail | Not | 2 |
| LTD121KM2M | | | reworkable | |
| Reworkability on NEC NL | Pass - | Pass - | Not | 2 |
| 10276BC24-13 | level 1 | level 1 | reworkable | |
| | | <30 sec | | |
| Glow marks on Toshiba | 2 | 2 | Should give | 0 |
| LTD121KM2M | | | rating of 4 | |
| Glow marks on NEC NL | 2 | 3 | Should give | 1 |
| 10276BC24-13 | | | rating of 4-5 | |
| Pooling on LTD 121KM2M | 3 | 3 | 5 | 3 |

Examples 13-15

| | Example 13 | Example 14 | Example 15 |
|---|---|---|---|
| Ingredient | | | |
| Oligomer aliphatic urethane | | | |
| acrylate (Sartomer CN9002) | | | |
| Oligomer - aliphatic urethane | | | |
| acrylate (Cytec Ebecryl 230) | | | |
| Monofunctional Monomer - cyclic | | | |
| trimethylolpropane formal acrylate | | | |
| (Sartomer SR531) | | | |
| Monofunctional Monomer - | 14.3 | 23.3 | 13.3 |
| phenoxyethyl acrylate (Sartomer | | | |
| SR339) | | | |
| Monofunctional Monomer - | | | |
| isobornyl- acrylate (Sartomer | | | |
| SR506A) | | | |
| Plasticizer - dibutoxy- ethoxyformal | | | |
| (Sartomer Cryoflex SR660) | | | |
| Plasticizer - dibutoxyethoxy- ethyl | 30 | 20 | 30 |
| adipate (Sartomer Wareflex SR650) | | | |
| Chain Transfer Agent - penta- | 7 | 8 | 8 |
| erythritol tetrakis(3-mercapto- | | | |
| proprionate) [PET AMAP] | | | |
| Chain Transfer Agent - 2-mer- | | | |
| captobenzothiazole | | | |
| Photoinitiator - 2,4,6-trimethyl- | | | |
| benzoylphenylphosphine oxide | | | |
| (Esacure TPO) | | | |
| Photoiniator - difunctional α-hydroxy | 1 | 1 | 1 |
| ketone (Esacure ONE) | | | |
| Photoiniator - 1-hydroxy-cyclohexyl- | | | |
| phenyl-ketone (Ciba Irgacure 184) | | | |
| Surfactant - Zonyl FSO-100 | 0.2 | 0.2 | 0.2 |
| Test Data | | | |
| Modulus (from Instron testing) [Mpa] | | | |
| Mean stress [Mpa] at 33% strain | | | |
| Reworkability on Toshiba | | | |
| LTD121KM2M | | | |
| Reworkability on NEC NL | 4 | 5 | 5 |
| 10276BC24-13 | | | |
| Glow marks on Toshiba | 0 | 1 | 1 |
| LTD121KM2M | | | |
| Glow marks on NEC NL | 1 | 1 | 1 |
| 10276BC24-13 | | | |
| Pooling on LTD 121KM2M | 3 | 3 | 2 |

Key for Table 1:
1. Note: Reworkability level 1 easy reworkability, level 2 harder to rework due to sticky adhesive.
2. Note: reworkability on Toshiba LTD121KM2M is more difficult due to rough polarizer surface increasing the adhesion of the adhesive. This resulted in cracking of the glass of the polarizer and a fail rating.
3. All composition values reported in Table 1 are in weight percent unless otherwise noted.
4. All values listed as “should give a rating of” are prophetic and are believed by the inventors to be the results that would be obtained if the experiments were done as indicated.
5. Reworkability scale for samples 14-17 is different than for other samples and is defined below.
6. For sample 14, 2 = reworkability good, wire cutting easy, adhesion slightly higher than before & tacky, adhesive sticks less to surface
7. For sample 15 (NEC LCD), 4 = reworkability fair, wire cutting less difficult thAN 16 & 17, adhesion high and very tacky, adhesive sticks to surface of LCD
8. For sample 16 (NEC), 5 = reworkability difficult, wire cuting difficult, adhesion very high & very tacky, adhesive sticks to surface of LCD
9. For sample 17 (NEC), 5 = reworkability difficult, wire cuting difficult, adhesion very high & very tacky, adhesive sticks to surface of LCD
10. Cells with blank test entries = not tested or data not yet available
11. Comp. Ex = Comparative Example
12. While not being bound by any theory, inventors believe that Ex. 11 is comparative because there is no plasticizer present; the result is that the cured adhesive has too high a modulus and is not sufficiently elastic and too high a level of adhesion with itself in relation to that for the LCD, etc. and therefore is not reworkable and also does not have desirable properties for low levels of pooling and glow marks.
13. While not being bound by any theory, inventors believe that Ex. 2 is comparative because the level of chain transfer agent is zero and consequently there is insufficient chain termination during photopolymerization and the resulting photopolymer (cured adhesive) has too high a modulus such that the cured adhesive is not elastic and does not have sufficient interpenetrating polymer network (IPN) levels such that the cured adhesive is too stiff and brittle and does not act appreciably as a cushion to eliminate or reduce undesirable glow mark formation and pooling formation in LCDs bonded with the adhesive to a glass plate.

### Examples 16-19

These examples illustrate that shaded curing of adhesive is feasible if the composition has a photoinitiator that absorbs light significantly in the visible region (e.g. around 400 nm or above).

Samples were tested that contained the photoinitiators listed below; these photoinitiators have the absorbance characteristics as listed below.

### Photoinitiator Absorbance Maximum Above 320 nm

| | |
|---|---|
| Irgacure 907 | below 320 nm (no significant absorbance at 400 nm) |
| Irgacure 184 | 330 nm (no significant absorbance at 400 nm) |
| Esacure ONE | 320 nm (no significant absorbance 400 nm) |
| Esacure TPO | ~370 nm (significant absorbance out to about 420 nm) |

### Shaded Cure Test Method

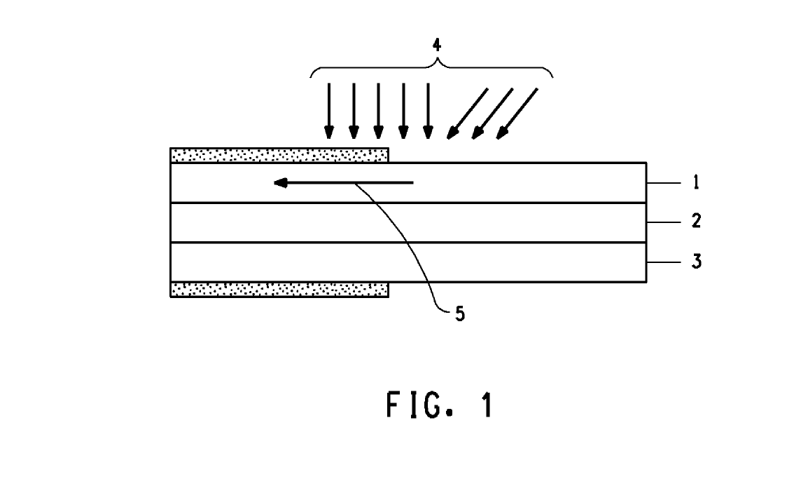

For each of these examples, approximately 7 grams of adhesive was placed between two layers of 3 mm thick soda lime glass pieces of 4 inch by 6 inch. About half the glass was covered both on top and bottom of this structure with black tape from 3M, Scotch brand black polyethylene tape type 481 (tape is purchased at 3 inch width). This structure was then passed through the Fusion UV fixture at a speed of 3 ft./minute, at the intensity of about 2.8 W/cm2 with the exposure about 6.8 J/cm2. This structure (the shaded cure test structure) is illustrated in FIG. 1. With regard to this test structure, 1 is layer #1, 2 is layer #2, and 3 is layer #3. The vertical and slanted arrows (4) in FIG. 1 represent UV light incident upon the test structure. The horizontal arrow 5 represents light piping along the glass. As shown in FIG. 1, the spotted rectangles represent black tape that is present and which covers portions of the test structure during execution of this test method.

The resultant cured adhesive was tested by removal of the tape after exposure and testing the cure by using a probe to test if the area under the black tape had hardened or remained as a liquid.

TABLE 2
Formulations and Dark Cure Results

| | Example 18 | Example 17 | Example 18 | Example 19 |
|---|---|---|---|---|
| Ingredients: | weight % | weight % | weight % | weight % |
| Aliphatic Urethane Diacrylate CN9002 | 47.5 | 47.5 | 55.4 | |
| Aliphatic Urethane Diacrylate CN9023 | | | | 56.0 |
| Sartomer SR484 Octyl/Decyl¹ Acrylate | | | | 16 |
| Sartomer SR506 Isobornyl acrylate | | | | 16 |
| Sartomer SR339 Phenoxyethyl acrylate | 35 | 35 | 31.3 | |
| Dibutoxyethoxyethyl Adipate Wareflex | 10 | 10 | 5.00 | |
| SR650 (Sartomer) | | | | |
| TegMer ® 804S Tetraethylene glycol di-2- | | | | 7.0 |
| ethylhexoate (Hallstar Co.) | | | | |
| Pentaerythritol tetra-3- | 7.0 | 7.0 | 8.0 | 4.6 |
| mercaptopropionate (Evans Chemetics) | | | | |
| PETMP | | | | |
| Irgacure 907 (alpha-aminoketone) | 0.5 | | | |
| Esacure ONE (Difunctional alpha- | | | 0.25 | |
| hydroxyketone) | | | | |
| Irgacure 184 (alpha-hydroxyketone | | 0.5 | | |
| Esacure TPO (Mono Acyl Phosphine | | | | 0.35 |
| oxide, MAPO) | | | | |
| Dark Cure Depth from Black Tape Edge | 0-2 mm | 0-2 mm | 0-2 mm | ~30 mm |

¹Octyl/Decyl Acrylate is a mixture of octyl acrylate and decyl acrylate.

Procedure used for Examples 16-19: Weigh out Monomers into plastic container (appropriate size depending on batch size) Next weigh out plasticizer carefully pouring into monomer solution. Then weigh out photoinitiator into mixture. With overhead stirring, stir mixture until photoinitiator is fully dissolved (˜2-3 hrs) Next add PETMP and continue stirring for ˜30 min. In a new container weigh out CN 9002 and then add first mixture into the Aliphatic urethane oligomer container. Return to stirrer and allow to stir for ˜1 hr. or longer

Table 2 shows results of the depth of shaded cure under the black tape. By use of a light piping mechanism the use of a photoinitiator with a strong absorbance around 400 nm (as seen in Example 19), one could get the curing of the adhesive under the black tape. Compositions that contain photoinitiators that have no significant absorbance at 400 nm are not cured by the light piping of the light along the glass to polymerize the adhesive (as seen in Examples 16-18). Light piping results in transmitted light along the glass axis from one end to the other even when the light is incident along a different direction or axis.

### Examples 20-24

This set of examples illustrates the effects of changes in certain components upon the propensity of the resulting formulation to exhibit yellowing.

### Yellow Index Test Method

### Background:

Visually, yellowness is associated with general product degradation by light, chemical exposure, and processing. Yellowness indices are used to quantify degradation with a single value. It can be used when measuring clear, near-colorless liquids or solids in transmission and near-white, opaque solids in reflectance.

### Conditions for Measurement of Yellow Index:

### Instrumental:

HunterLab Color Quest XE spectrophotometer.

### Color Scale: CIE XYZ

### Illuminant/Angle: D65/100

Yellow Index per ASTM D1925 is calculated per formula shown in ASTM D1925 using tristimulus values of measurement. Even though the ASTM D1925 method was withdrawn in 1995, the formula still provides useful information. The index is always calculated for C/20, regardless what illuminant and observer are chosen.

### Test Samples:

1 inch×3 inch glass to glass bonded slides of approximately 0.5 gram adhesive with adhesive thickness of ˜1 mm (using the slides as shims to get the 1 mm thickness). The curing of adhesive is the same as used for the dark cure test as indicated in that section.

### Weatherometer:

The weatherometer used in this test was the Atlas CI-5000.

Test chamber controlled by reading the Chamber DB (dry bulb) reading. DB set to control to 42.0° C. Chamber uses a blower motor along with a smart damper to control temperature. The lamp is a 12000 watt Zenon lamp and is located in the center of chamber. Sample rack consists of a carousel of diameter approximately 38″ that rotates around the lamp. The speed of the sample rack rotates around the lamp and is controlled by the irradiance setting.

The test is carried out at 0.68 W/m² @ 340 nm. At this setting the sample rack covers a complete 3600 revolution every 55-57 seconds.

### Yellow Index Results:

Table 3 illustrates the yellow index for various ingredients in the adhesive formulation. The yellow index was calculated from the sample measurements conducted as described above.

Comparison of formulation A vs. B shows the effect of a higher yellow index when the oligomer has a yellowing inhibitor (MEHQ) present versus the oligomer having a relatively non-yellowing inhibitor present. A yellow index of 2.8 was measured at 168 hours for formulation A having a non-yellowing inhibitor (Irganox 1035). Formulation B, with MEHQ, has not yet been measured but, if measured, is prophesized to possess a yellow index of ˜19.5 based on a related formulation that was measured.

Comparison of Formulations A and C shows the effect of using a yellowing monomer (phenoxyethyl acrylate) in comparison to use of a relatively non-yellowing monomer. Formulation C, with phenoxyethyl acrylate, has not yet been measured but, if measured, is prophesized to possess a yellow index of ˜12.5 based on a related formulation that was measured. This value is much higher than the measured yellow index of formulation A that was 2.87 at 168 hours in the weatherometer.

Comparison of formulations A and formulation D illustrates the increased yellow index when using a plasticizer that exhibits a higher amount of yellowing when exposed in the weatherometer testing. Formulation A using the tetraethylene glycol di-2-ethylhexoate plasticizer gave a yellow index that was measured as 2.87 at 168 hours in the weatherometer. Formulation D which uses a more yellowing plasticizer, dibutoxyethoxyethyl adipate, has not yet been measured but, if measured, is prophesized to possess a yellow index of ˜14.0 based on a related formulation that was measured.

Comparison of formulation A and formulation E illustrates the increased yellow index when using a photoinitiator that forms a yellow compound when exposed to simulated sunlight as in the weatherometer testing. Formulation A gave a measured yellow index at 504 hours of 4.8. Formulation E using Irgacure 184, a photoinitiator that forms a yellow compound on excessive UV exposure, has a yellow index that is measured at 7.5 at 504 hours.

TABLE 3

| | | Example 21 | Example 22 | Example 23 | |
|---|---|---|---|---|---|
| | Example 20 | (Prophetic) | (Prophetic) | (Prophetic) | Example 24 |
| | Formulation | Formulation | Formulation | Formulation | Formulation |
| Ingredients: | A | B | C | D | E |
| Sartomer Aliphatic | 56 | 56 | 56 | 56 | 56 |
| urethane diacrylate | | | | | |
| CN9002 (uses yellowing | | | | | |
| inhibitor MEHQ) | | | | | |
| Isobornyl acrylate (Non- | 16 | 16 | 16 | 16 | 16 |
| yellowing monomer) | | | | | |
| Octyl/Decyl Acrylates (low | 16 | 16 | 0 | 16 | 16 |
| to non-yellowing | | | | | |
| monomer) | | | | | |
| Phenoxyethyl acrylate | 0 | 0 | 16 | 0 | 0 |
| (yellowing monomer) | | | | | |
| TegMer 804S - | 7 | 7 | 7 | 0 | 7 |
| tetraethylene glycol di- | | | | | |
| 2ethylhexoate (low | | | | | |
| yellowing plasticizer) | | | | | |
| SR650 - | 0 | 0 | 0 | 7 | 0 |
| dibutoxyethoxyethyl | | | | | |
| adipate (a yellowing | | | | | |
| plasticizer) | | | | | |
| TPO -2,4,6- | 0.35 | 0.35 | 0.35 | 0.35 | 0 |
| trimethylbenzoyldiphenyl | | | | | |
| phosphine oxide (non- | | | | | |
| yellowing photoinitiator) | | | | | |
| Irgacure 184 (yellowing | 0 | 0 | 0 | 0 | 1.6 |
| photoinitiator) | | | | | |
| Pentaerythritol tetra-3- | 4.6 | 4.6 | 4.6 | 4.6 | 4.6 |
| mercaptopropionate | | | | | |
| (chain transfer agent) | | | | | |
| Yellow index - 168 hours | 2.87 | ~19.5 | ~12.5 | ~14.0 | |
| in weatherometer | | | | | |
| Yellow index - 504 hours | 4.8 | | | | 7.5 |
| in weatherometer | | | | | |

### Glow Marks, Pooling & Reworkability

Three formulations were made according to Table 4. The resultant formulations gave tensile properties of the cured adhesive layer as shown in Table 5. This variation of tensile properties illustrate the effect on the glow marks and pooling on bonded LCD panels according to the attached summary of bonded LCD panels. The bonding was done as described above.

Results show that the higher modulus formulation (formulation A) shows somewhat poorer results for glow marks at the temperatures indicated in the table. These are evaluated after storage for 2 hours at the temperature indicated. The letters refer to the position within the bonded panel that shows the extent of glow marks according to the evaluation criteria. Pooling is acceptable across the entire range of tensile properties.

Reworkability was demonstrated using 4 inch by 6 inch glass to glass bonded samples of the adhesive using the process described below with results shown in Table 5. The results show that as the modulus becomes lower, reworkability becomes more difficult.

The process and test device used for reworkability testing is as follows:

The test device was used to effect de-bonding of the glass/cured adhesive/glass test samples. The device that was used consisted of a 14 inch travel linear stage that used a ball screw drive which was powered by a Nema 23 size stepper motor. The stepper motor speed and direction was controlled by a Thechno-Isel Mac 100 single axis controller. The controller was programmed to drive, at a preprogrammed speed, the linear stage with the mounting fixture affixed to it and holding the test sample, until it reached a home switch at which point it stopped. A cutting thread or wire contained on a spool was utilized. This spool was mounted to a vertical plate that was perpendicular to the linear stage. The spool was supported on this plate via an axle and mount. On the opposite end of this axle there was a friction brake that applied drag to the line as it was being pulled. The braided line was pulled through the adhesive via a motor driven pulley that was mounted on the far side of the vertical mounting plate. The speed of the line travel was controlled via a DC power supply. PowerPro™ 80# and 100# fishing line was used as a cutting thread that was operated with a line speed of approximately 17 feet/minute under ambient conditions.

TABLE 4

| | Example 25 | Example 28 | Example 27 |
|---|---|---|---|
| | Formulation | Formulation | Formulation |
| | A | B | C |
| Ingredients: | weight % | weight % | weight % |
| Aliphatic Urethane Diacrylate | 56.00 | 56.00 | 56.00 |
| (Sartomer CN9023) | | | |
| Octyl/Decyl Acrylate | 15.55 | 15.975 | 15.15 |
| (Sartomer SR3484) | | | |
| Isobornyl acrylate (Sartomer | 15.55 | 15.975 | 15.15 |
| SR506) | | | |
| Tetraethylene glycol di-2- | 7.00 | 7.00 | 7.00 |
| ethylhexoate | | | |
| Pentaerythritol tetra-3- | 4.3 | 4.80 | 5.5 |
| mercaptopropionate | | | |
| 2,4,6-trimethylbenzoyl- | 0.70 | 0.35 | 0.70 |
| diphenylphosphine oxide | | | |
| Tinuvin 123 | 0.5 | 0.10 | 0.5 |

TABLE 5

| | | Stress (Mpa) |
|---|---|---|
| | Modulus (MPa) | at 33% Strain |
| Formulation A | 0.05 | 0.014 |
| Formulation B | 0.033 | 0.008 |
| Formulation C | 0.016 | 0.004 |

Results obtained for these three formulations with respect to glow marks and pooling are summarized in Table 6.

TABLE 6

| | | Glow Marks | | | | | | | | |
|---|---|---|---|---|---|---|---|---|---|---|
| LCD | | Room | | | | | | Pooling | | |
| Type | Adhesive | Temp | 50° C. | 55° C. | 60° C. | 65° C. | 70° C. | Grey | White | Black |
| NEC | Formulation A | 0 | A0.5 | AE0.5 | AE1 | AE1 | A2E1C | 0 | 0 | 0 |
| | | | | | | | 0.5 | | | |
| NEC | Formulation B | 0 | 0 | 0 | 0 | 0 | 0 | 0 | 0 | 0 |
| NEC | Formulation C | 0 | 0 | | 0 | | 0 | 0 | 0 | 0 |
| Hydris | Formulation B | 0 | 0 | AC | AC | CD | CDHI | 0 | 0 | 0 |
| | | | | 0.5 | 0.5 | 0.5 | 2 | | | |

| Severity rankings of glow marks | Severity rankings of pooling |
|---|---|
| 0 = no abnormal visible | 0 = no pooling observed |
| 1 = just visible off-axis | 1 = slight pooling near edge(s) |
| 2 = obvious on-axis | 2 = medium low level of pooling |
| 3 = objectionable discoloration | 3 = medium level of pooling |
| 4 = severe discoloration | 4 = medium high level of pooling |
| 5 = dark yellow-brown | 5 = high level of pooling |

Pooling test results obtained for gray, white, and black LCDs are shown in Table 6.

Letters reported in Table 6 refer to the location(s) within the LCD panel where glow mark(s) and/or pooling were observed as shown below.

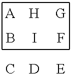

The results obtained for the three formulations with regard to reworkability are summarized in Table 7.

TABLE 7
Reworkability

| | Cutting through | Removal of | Removal of Adhesive |
|---|---|---|---|
| | Adhesive layer | Glass | from Glass |
| Formulation A | Good | Good | Good |
| Formulation B | Good | Good | Good (but slower) |
| Formulation C | Fair | Poor | Poor |

Samples were glass to glass bonded adhesive using 3 mm thick soda lime glass on bottom and 1.1 mm soda lime glass on top.
Adhesive bonded layer was 0.5 mm thick.

### For Cutting Through Adhesive Layer:

Good=ease of cutting through without significant stress on the cutting filament.

Fair=excess strain on the cutting filament sometimes resulted in the thin glass fracturing

Poor=filament snapped sometimes due to fracture of the glass

### For Removal of Glass:

Good=ease of separation of the top glass layer from lower glass layer

Fair=some difficulty in separation of the upper glass from the lower glass

Poor=Very difficult to remove upper glass layer lower glass

For Removal of Adhesive from Glass:

Good=easy to remove adhesive from glass

Fair=removal of adhesive from glass is more difficult and takes longer (˜10-12 minutes

Poor=very difficult to remove the adhesive from the glass and may take longer times.

What is claimed is:

1. An actinically curable adhesive composition comprising:
a) an aliphatic urethane acrylate having a plurality of ethylenically unsaturated groups;
b) a (meth)acrylate monomer;
c) a photoinitiator;
d) a plasticizer; and
e) pentaerythritol tetrakis(3-mercaptopropionate)
wherein the level of the (meth)acrylate monomer plus the level of the plasticizer together range from 30 weight percent to 50 weight percent of the total weight of the composition.

2. The actinically curable adhesive composition of claim 1 wherein the composition in its actinically cured state in use in a display device is reworkable.

3. The actinically curable adhesive composition of claim 1 wherein the composition in its actinically cured state and in use for bonding a glass plate to a front polarizer of an LCD exhibits a glow mark test rating of 2 or less in a glow mark test.

4. The actinically curable adhesive composition of claim 1 wherein the composition in its actinically cured state and in use for bonding a glass plate to a front polarizer of an LCD exhibits a pooling test rating of 1 or less in a pooling test.

5. The actinically curable adhesive composition of claim 1 wherein level of the plasticizer ranges from 3 weight percent to 40 weight percent of the total weight of the composition.

6. The actinically curable adhesive composition of claim 1 wherein the composition upon curing exhibits a modulus of less than or equal to 0.27 megapascals.

7. The actinically curable adhesive composition of claim 6 wherein the composition upon curing exhibits a modulus that ranges from 0.01 megapascals to 0.1 megapascals.

8. The actinically curable adhesive composition of claim 7 wherein the composition upon curing exhibits a modulus that ranges from 0.016 megapascals to 0.05 megapascals.

9. The actinically curable adhesive composition of claim 1 wherein the (meth)acrylate monomer is selected from the group consisting of cyclic trimethylpropane formal acrylate, octyl/decyl acrylate, and isobornyl acrylate.

10. The actinically curable adhesive composition of claim 1 wherein the plasticizer is selected from the group consisting of tetraethylene glycol di-2-ethylhexoate and (polyethylene glycol) 400 di-2-ethylhexoate.

11. The actinically curable adhesive composition of claim 1 wherein the photoinitiator is selected from the group consisting of phenyl bis(2,4,6-trimethylbenzoyl)phosine oxide and 2,4,6-trimethylbenzoyldiphenyl phosphine oxide.

12. A method of bonding a substrate to a display module, said method comprising the steps of:
1) applying an actinically curable adhesive composition comprising:
a) an aliphatic urethane acrylate having a plurality of ethylenically unsaturated groups;
b) a (meth)acrylate monomer;
c) a photoinitiator;
d) a plasticizer; and
e) pentaerythritol tetrakis(3-mercaptopropionate);
to a surface selected from the group consisting of a surface of the display module, a surface of the substrate, and both a surface of the display module and a surface of the substrate; wherein the level of the (meth)acrylate monomer plus the level of the plasticizer together range from 30 weight percent to 50 weight percent of the total weight of the composition;
2) contacting the surface of the substrate with the actinically curable adhesive composition and the liquid crystal display such that the adhesive is sandwiched between the surface of the substrate and the surface of the display module; and
3) exposing the actinically curable adhesive composition to actinic radiation at a sufficient level to at least partially cure the actinically curable adhesive composition and thereby afford a bonded liquid crystal display/substrate element.

13. The method of claim 12 wherein the composition in its actinically cured state in use in a display device is reworkable.

14. The method of claim 12 wherein the composition in its actinically cured state and in use for bonding a glass plate to a front polarizer of a liquid crystal display device exhibits a glow mark test rating of 2 or less in a glow mark test.

15. The method of claim 12 wherein the composition in its actinically cured state and in use for bonding a glass plate to a front polarizer of a liquid crystal display device exhibits a pooling test rating of 1 or less in a pooling test.

16. The method of claim 12 wherein level of the plasticizer in the composition ranges from 3 weight percent to 40 weight percent of the total weight of the composition.

17. The method of claim 12 wherein the composition upon curing exhibits a modulus of less than or equal to 0.27 megapascals.

18. The method of claim 17 wherein the composition upon curing exhibits a modulus that ranges from 0.01 megapascals to 0.1 megapascals.

19. The method of claim 18 wherein the composition upon curing exhibits a modulus that ranges from 0.016 megapascals to 0.05 megapascals.

20. The method of claim 12 wherein the (meth)acrylate monomer in the composition is selected from the group consisting of cyclic trimethylpropane formal acrylate, octyl/decyl acrylate, and isobornyl acrylate.

21. The method of claim 12 wherein the plasticizer in the composition is selected from the group consisting of tetraethylene glycol di-2-ethylhexoate and (polyethylene glycol) 400 di-2-ethylhexoate.

22. The method of claim 15 wherein the photoinitiator in the composition is selected from the group consisting of phenyl bis(2,4,6-trimethylbenzoyl)phosphine oxide and 2,4,6-trimethylbenzoyldiphenyl phosphine oxide.
